(19) United States
(12) Patent Application Publication
(10) Pub. No.: US 2005/0069725 A1
(43) Pub. Date: Mar. 31, 2005

(54) Lead-free solder composition for substrates

(76) Inventor: Premakaran T. Boaz, Livonia, MI (US)

Correspondence Address: Bliss McGlynn, P.C.;Suite 600, 2075 West Big Beaver, Troy, MI, 48084, US

(21) Appl. No.: 10/744,326

(22) Filed: Dec. 23, 2003

Related U.S. Application Data
(60) Provisional application No. 60/484,952, filed on Jul. 3, 2003.

(51) Int. Cl. C22C 13/00; B32B 15/01

(52) U.S. Cl. 428/646; 420/557

(57) ABSTRACT

A lead-free solder composition for soldering onto a substrate includes a solder having Tin (Sn) and Silver (Ag); and an additive having a low coefficient of thermal expansion.

### CROSS-REFERENCE TO RELATED APPLICATION(S)

The present application claims the benefit of U.S. Provisional Patent Application Ser. No. 60/484,952, filed Jul. 3, 2003, and entitled “Lead-Free Solder Composition for Use on Glass Substrates.”

### BACKGROUND OF THE INVENTION

1. Field of the Invention

The present invention relates generally to solder compositions and, more particularly, to a lead-free solder composition for a substrate.

2. Description of the Related Art

It is known that solder is a material used to provide connections either between various items or to secure an item to a substrate. Solder is also used in several technical fields, such as electrical, mechanical, or thermal. However, the specific composition of solder or type of solder alloy varies widely between technical fields and even within a given field, depending on the application. Traditionally, solder largely consisted of lead because of its physical and chemical characteristics (i.e. wettability, melting point, Malleability, rate of thermal expansion, etc.). However, lead solder has become known as a source of environmental pollution and federal legislation has mandated a reduction in the content of lead in solder.

As a result, lead-free solder has been introduced into various technical fields and is currently used in numerous applications. As disclosed in U.S. Pat. Nos. 5,066,544, 5,918,795, and 6,371,361, lead-free solder or reduced lead content solder is used to solder electronic components in both the microelectronic and conventional electronic fields.

However, there exist other technical fields where the afore-mentioned lead-free solders are deficient. Within the technical field of soldering onto a ceramic or glass substrate, such as an automobile window or windshield, known lead-free solders are less desirable because they contain alloy compositions which possess a coefficient of thermal expansion nearly twice that of the substrate and less malleable than lead. As a result, the solder can separate from and/or crack the substrate during a substantial change in climatic temperature, which is known as “thermal shock.”

U.S. Pat. No. 6,319,461 to Domi et al. discloses a lead-free solder for soldering a component to a ceramic or glass substrate to resist thermal shock. In that patent, the lead-free solder includes a small amount of titanium is dissolved into tin to provide stability up to 400° C. as its essential component in combating thermal shock. However, the price and properties of Titanium when included in a solder give rise to concerns over cost and workability of the solder at certain temperatures. As a result, the titanium laden solder composition is used to bond to bare glass. However, this composition is very likely to break the glass if sufficient quantity is attached to a silver ceramic coated substrate since the coefficient of expansion is close to that of tin and will not be very malleable due to the lack of lead.

Therefore, there is a need in the art to provide a lead-free solder for use on a glass or ceramic substrate. There is also a need in the art to provide a lead-free solder composition for use on a glass or ceramic substrate that is a cost-effective and workable. There is further a need in the art to provide a lead-free solder composition for use on a glass or ceramic substrate having a low coefficient of thermal expansion to reduce the likelihood of thermal shock.

### SUMMARY OF THE INVENTION

Accordingly, the present invention is a lead-free solder composition for soldering onto a substrate including Tin (Sn) and Silver (Ag) as well as an additive having a low coefficient of thermal expansion.

One advantage of the present invention is that a lead-free solder composition is provided for use on a glass or ceramic substrate. Another advantage of the present invention is that the lead-free solder composition has a low coefficient of thermal expansion to combat thermal shock for soldering to a glass or ceramic substrate. Yet another advantage of the present invention is that the lead-free solder composition is cost effective, easy to manufacture, and easy to apply to a glass or ceramic substrate. Still another advantage of the present invention is that the lead-free solder composition includes a solder and an additive that can be adjusted to substantially correlate the coefficient of thermal expansion of the solder composition to the coefficient of thermal expansion of the substrate to which the solder composition is to be secured. A further advantage of the present invention is that the lead-free solder composition is capable of use in connection with a layer of Indium to promote greater adhesion to a substrate. Yet a further advantage of the present invention is that the lead-free solder composition includes Bismuth (Bi). Still a further advantage of the present invention is that the lead-free solder composition includes an additive such as fused Silica (SiO₂) or Invar®. Another advantage of the present invention is that the lead-free solder composition may include the additive in the form of granules encapsulated in a lead-free, wettable, metal alloy such as Copper (Cu), Nickel (Ni) or Silver (Ag). Another advantage of the present invention is that the lead-free solder composition includes an additive in granular form that may also be a Nickel (Ni) or Iron (Fe) alloy.

Other features and advantages of the present invention will be readily appreciated, as the same becomes better understood, after reading the subsequent description taken in conjunction with the accompanying drawings.

### BRIEF DESCRIPTION OF THE DRAWINGS

FIG. 1 is an assembly of a lead-free solder composition, according to the present invention, on a hardware component before melt.

FIG. 2 is a view similar to FIG. 1 of the solder composition secured to a hardware component and a substrate including an enhanced bonding sub-layer of Indium after melt.

### DESCRIPTION OF THE PREFERRED EMBODIMENT(S)

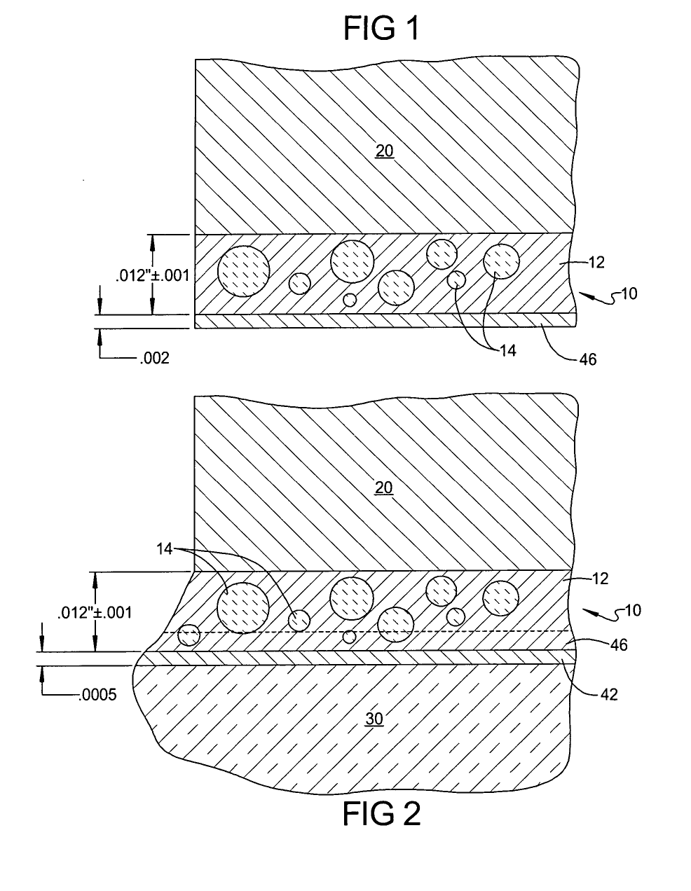

Referring to FIG. 1, one embodiment of a lead-free solder composition 10, according to the present invention, is shown for soldering a hardware component 20, such as a copper terminal, and a substrate 30 together. The substrate 30 is a glass or silver ceramic coated substrate, for example, an automotive window or windshield. It should be appreciated that the hardware component 20 and substrate 30 are conventional and known in the art.

The lead-free solder composition 10 includes a solder 12 and an additive 14 having a low coefficient of thermal expansion such as disposed within the solder 12. In one embodiment, the solder 12 includes Tin (Sn) and Silver (Ag), wherein the percent composition by weight of the two components is from about 95% to about 97% Tin and from about 5% to about 3% Silver. In another embodiment, the solder 12 may also include Bismuth (Bi), wherein the percent composition by weight of the three components is from about 61% to about 39% Tin, from about 1% to about 3% Silver, and from about 59% to about 37% Bismuth. In yet another embodiment, the solder 12 may be coated with a layer of Indium 46, approximately 0.002 inches thick, to improve bonding of the hardware 20 to the substrate 30. It should be appreciated that Bismuth has a low coefficient of thermal expansion.

Referring to FIGS. 1 and 2, the additive 14 has a low coefficient of thermal expansion and is added to the solder 12. The additive 14 may be any wettable material having a low coefficient of thermal expansion such as zero to about 8 ppm/deg. C. For example, the additive 14 may be fused Silica, Zirconium oxide, Invar®, an alloy of about 36% by weight Nickel (Ni), or an alloy of about 64% by weight Iron (Fe). Preferably, the additive 14 is in the form of granules to form a granular additive. To improve wettability of the fused Silica (SiO₂), the granules of the additive 14 may be encapsulated in a metal such as copper (Cu), nickel, or silver. The size of the granules for the additive 14 may range from about 5 to about 400 microns, preferably from about 10 to about 250 microns.

The additive 14 of Invar® may also be included within the solder 12 in other forms. For example, the additive 14 of Invar® could be sandwiched in the form of a thin foil from about 0.001 to about 0.020 inches thick, preferably about 0.005 inches thick. This foil may be further perforated with pass through holes to provide a physical connection between the two solder layers on either sides of the Invar® foil. It should be appreciated that the Invar® foil functions to reduce the thermal stress as though it was added as granules.

### EXPERIMENTAL

Aspects of the present invention will now be illustrated, without intending any limitation, by the following examples. Unless otherwise indicated, all parts and percentages are by weight.

| | Solder # 1 | | Solder # 2 | |
|---|---|---|---|---|
| | (95 Sn, 5 Ag) | | (57 Bi, 42 Sn, 1 Ag) | |
| | CTE | % of Thermal | CTE | % of Thermal |
| % Content | Reduction | Shock reduction | Reduction | Shock reduction |
| of Invar | PPM/ | on Soda | PPM/ | on Soda |
| granules | deg. C. | lime glass | deg. C. | lime glass |
| 10 | 25 | 16 | 16 | 32 |
| 20 | 50 | 31 | 32 | 46 |
| 30 | 75 | 47 | 48 | 68 |
| 40 | 100 | 62 | 64 | 91 |

The percent weight of the solder 12 and additive 14 for the lead-free solder composition 10 can be contingent upon the coefficient of thermal expansion of the substrate 30 in order that the coefficient of thermal expansion of the lead-free solder composition 10 be substantially similar to that of the substrate 30. However, those having ordinary skill in the art will appreciate that while the coefficient of thermal expansion of the lead-free solder composition 10 may be substantially similar to that of the substrate 30, they need not match exactly. By way of example, when using fused Silica as the additive 14, the percent weight of the lead-free solder composition 10 is at least 90% solder 12 and at least 10% additive 14 by weight to secure the lead-free solder composition 10 (and included hardware 20) to the substrate 30 having a coefficient of thermal expansion between about 85×10⁻⁷ to about 92×10⁻⁷.

Referring to FIG. 2, the lead-free solder composition 10 is placed on the hardware 20 and secured to the substrate 30 by conventional means, i.e. applying heat to melt the solder 12 and attach the hardware to the substrate 30, thereby trapping the additive 14 between the hardware 20 and the substrate 30. It should be appreciated that the lead-free solder composition 10 may be soldered to the substrate 30 and coated with a silver ceramic material or Indium 42 to promote adhesion of the lead-free solder composition 10 to the substrate 30.

When the joined hardware 20 and substrate 30 are exposed to low climatic temperatures, the solder 12 will attempt to contract at a rate higher than that of the substrate 30. However, the trapped additive 14 will prevent the high contraction rate of the solder 12 and absorb the stress created by the same, causing the substrate 30 to receive little or no stress from the contraction, thereby preventing thermal shock.

The present invention has been described in an illustrative manner. It is to be understood, that the terminology that has been used, is intended to be in the nature of words of description rather than of limitation and the examples are intended to illustrate and not limit the scope of the present invention.

Many modifications and variations of the present invention are possible in light of the above teachings. Therefore, the present invention may be practiced other than as specifically described.

1. A lead-free solder composition for soldering onto a substrate comprising:
a solder comprising Tin (Sn) and Silver (Ag); and
an additive having a low coefficient of thermal expansion.

2. A lead-free solder composition as set forth in claim 1 wherein said solder further comprises by weight from about 95% to about 97% Tin (Sn) and from about 5% to about 3% Silver (Ag).

3. A lead-free solder composition as set forth in claim 1 wherein said solder further comprises Bismuth (Bi).

4. A lead-free solder composition as set forth in claim 1 wherein said solder further comprises, by weight, between 61% and 39% Tin (Sn), between 1%-3% Silver (Ag) and between 59% and 37% Bismuth (Bi).

5. A lead-free solder composition as set forth in claim 1 wherein said solder is coated with Indium.

6. A lead-free solder composition as set forth in claim 5 wherein said Indium has a thickness of approximately 0.002 inches.

7. A lead-free solder composition as set forth in claim 1 wherein said additive comprises fused Silica (SiO₂).

8. A lead-free solder composition as set forth in claim 7 wherein said fused Silica is encapsulated in Copper (Cu).

9. A lead-free solder composition as set forth in claim 7 wherein said fused Silica is encapsulated in Silver (Ag).

10. A lead-free solder composition as set forth in claim 7 wherein said fused Silica is encapsulated in Nickel (Ni).

11. A lead-free solder composition as set forth in claim 7 wherein said fused Silica is encapsulated in a lead-free wettable metal alloy.

12. A lead-free solder composition as set forth in claim 1 wherein said additive comprises Zirconium oxide.

13. A lead-free solder composition as set forth in claim 1 wherein said additive comprises Invar®.

14. A lead-free solder composition as set forth in claim 1 wherein said additive comprises about 36% by weight Nickel (Ni) alloy.

15. A lead-free solder composition as set forth in claim 1 wherein said additive comprises about 64% by weight Iron (Fe) alloy.

16. A lead-free solder composition as set forth in claim 1 wherein said additive is in the form of granules.

17. A lead-free solder composition as set forth in claim 16 wherein said granules have a size from about 5 microns to about 400 microns.

18. A lead-free solder composition as set forth in claim 1 wherein said additive is a foil having a thickness from about 0.001 inches to about 0.020 inches.

19. A lead-free solder composition as set forth in claim 1 wherein said additive is a foil having a plurality of apertures extending therethrough.

20. A lead-free solder composition for soldering onto a glass or ceramic substrate comprising:
a solder comprising Tin (Sn) and Silver (Ag); and
a granular additive having a low coefficient of thermal expansion.

21. A method of making a lead-free solder composition, said method comprising the steps of:
providing a first component being a solder of Tin (Sn) and Silver (Ag);
providing a second component being an additive; and
disposing the second component in the first component to form a lead-free solder composition.
